(19) United States
(12) Patent Application Publication
(10) Pub. No.: US 2004/0062839 A1
(43) Pub. Date: Apr. 1, 2004

(54) Packing for use when cooking dough and food items in a microwave oven

(76) Inventor: Steen Pedersen, Esbjerg V (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/416,925

(22) PCT Filed: Nov. 15, 2001
(86) PCT No.: PCT/DK01/00751

(30) Foreign Application Priority Data
Nov. 16, 2000 (DK) PA 2000 01719

(51) Int. Cl. A23B 4/00

(52) U.S. Cl. 426/110

(57) ABSTRACT

There is described packing (2) of cardboard and shaped as a tube, preferably horizontal, or a box for use in cooking dough products (38) and other fast-food products, such as pizzas, pita breads, French loaves, hamburgers, calzones, spring rolls, or breaded products, e.g. breaded chicken or fish pieces, in a microwave oven. The packing has a susceptor coating (4) on parts of internal areas, where a lower part of the packing has such a shape or is formed with such shaped spacers, by way of example legs (8,30), that provide access for ventilation for a part of the underside of the packing. The packing (2) at the underside part (16) and preferably in one or more side walls (6,24) have ventilation openings (36), the mutual position and shape of which are adapted to the shape of the packing, of the dough item and/or of the product. The packing according to the invention may be placed in an outer packing that by way of example consists of a plastic bag.

### BACKGROUND OF THE INVENTION

The present invention concerns a packing for use in cooking dough and food products n a microwave oven.

### DESCRIPTION OF THE PRIOR ART

Cooking of dough products, for example French loaves, or fast-food products comprising some kind of dough wrapping, for example spring rolls, have hitherto not been possible to post-bake in microwave oven with satisfactory result. Most often, it happens that the dough enveloping is not properly baked, that is it lacks crispness, because the surface still contains too much moisture, or over-backing with resulting scorching of the product occurs.

### SUMMARY OF THE INVENTION

The invention is a the packing for cooking dough products and other fast-food products by means of simple measures in a microwave oven in such a way that the packing ensures optimal baking conditions for dough products and other fast-food products, so that a crisp surface is achieved without over-baking or moisture accumulation in the surface of the food product.

The packing according to the invention comprises a lower part shaped or formed with such shaped spacing means, by way of example legs, that provide access for ventilation for a part of the underside of the packing, and that the packing at the underside part and preferably in one or more side walls have ventilation openings, the mutual position and shape of which are adapted to the shape of the packing and to the shape of the dough product, that the packing is formed as a horizontal tube with four-sides, preferably of rectangular cross-section and the spacing means at one side of the packing are a lower, projecting edge of the packing material and feet punched along a bending line at the opposite side of the packing.

The packing according to the invention may possibly be placed in an outer packing that by way of example is a plastic bag. Possibly a bag of pre-baked French loaves, as frozen goods, may contain a number of tube packings according to the invention for successive use in post-baking of one or more French loaves at a time in a microwave oven.

A particularly simple and advantageous embodiment of the invention may furthermore be achieved with the ventilation openings constituting narrow, elongate openings which are formed in a bottom part of the packing along opposite sides of the bottom part and along a lower part and preferably also along an upper part of opposite side walls of the packing.

Alternatively, the packing according to the invention may be formed as a horizontal tube with a circular cross-section, the packing being formed with a number of semi-circular cut-outs forming lugs of material which are designed to be bent out and constitute support legs for the packing.

As a further alternative, the packing according to the invention may be shaped as a horizontal tube with a triangular cross-section, the packing being formed along bending lines at opposite, outer edges of the packing, the cut-outs forming material tugs arranged for being bent out and constituting feet for the packing, and that the ventilation openings are constituted by narrow, elongate apertures formed in the side walls of the packing, preferably at both sides of the bottom of the packing.

As a still further alternative, the packing according to the invention may be shaped as a horizontal tube with an oval cross-section, the packing being formed with a number of for example semi-circular cut-outs forming lugs of material which are designed to be bent out and constitute support legs for the packing.

According to a further alternative, the packing according to the invention may be shaped as a horizontal tube with a hexagonal cross-section and preferably open ends, the packing being formed with a number of for example semi-circular cut-outs forming lugs of material which are designed to be bent out and constitute support legs for the packing.

### BRIEF DESCRIPTION OF THE DRAWINGS

The invention is explained in more detail in the following with reference to the drawing on which:

FIG. 1 shows a perspective view of an embodiment of a tubular packing according to the invention,

FIG. 2 shows a simplified, perspective view of the packing according to the invention of FIG. 1, particularly for illustrating the special feet on the packing,

FIG. 3 shows a schematic end view of the packing shown in FIGS. 1 and 2, shown with dough products with an oval cross-section, for illustrating the surrounding ventilation through respective ventilation openings of the packing,

FIG. 4 shows a perspective view of a further embodiment of a tubular packing according to the invention with a triangular cross-section,

FIG. 5 shows a perspective view of a further embodiment of a tubular packing according to the invention with oval cross-section,

FIG. 6 shows a schematic end view of the packing shown in FIG. 5, placed on a plane support surface,

FIG. 7 shows a perspective view of a still further embodiment of a tubular packing according to the invention with a hexagonal cross-section,

FIG. 8 shows a perspective view of a still further embodiment of a tubular packing according to the invention with a square cross-section, and

FIG. 9 shows perspective view of a still further embodiment of a tubular packing according to the invention with a circular cross-section.

### DETAILED DESCRIPTION OF THE INVENTION

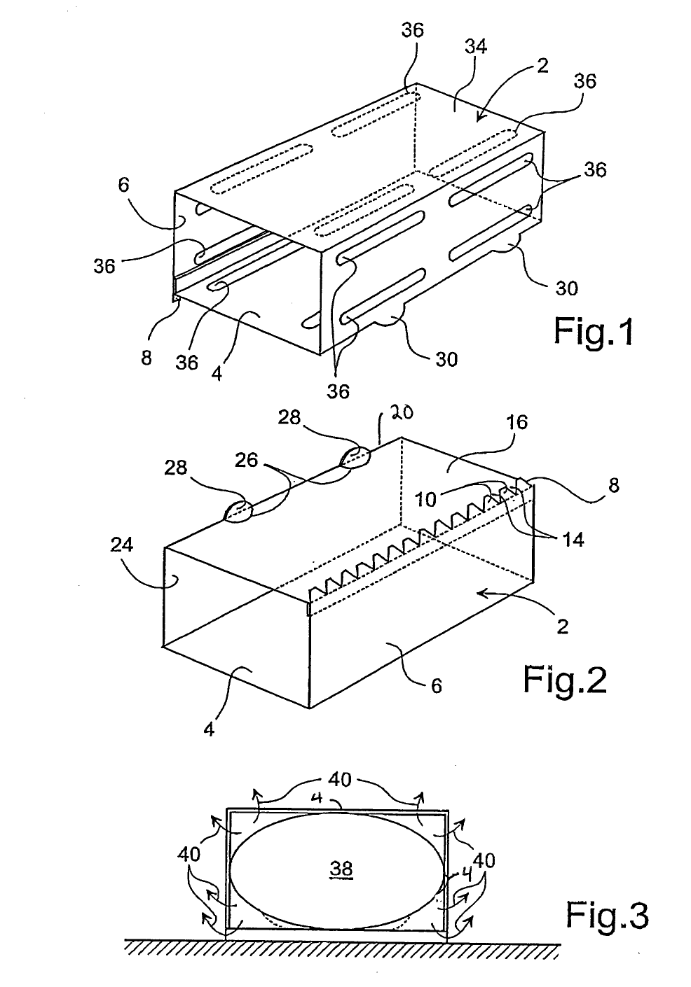

The packing 2 shown in FIGS. 1-3 is cardboard provided internally with a susceptor coating 4, and which has a tubular rectangular cross-section, in order to take up the least possible space. The packing 2 is intended for folding into a double walled, plane item which is raised to the tube shape only in the situation of use.

The tubular packing 2, which is for example intended for use in the final cooking of pre-baked dough items, for example French loaves, in a microwave oven, are folded and glued together in such a way that a side wall 6 has a lower, projecting edge part 8 which, as most clearly shown in FIG. 2, has saw-tooth shape, so that a large number of feet 10 with V-shaped interspaces 14 are formed, that is such that a bottom surface 16 of the tubular packing 2 may be lifted free from a plane support surface (FIG. 3).

At the opposite side, the tubular packing 2 is provided with semi-circular cut-outs 26 in connection with a bending edge 20 between the bottom surface 16 and a side wall 24. The cut-outs form material bags 28 which are arranged to be bent out and constitute support legs 30 for the packing 2 so that the packing may be lifted off the support surface 18 at opposite sides of the bottom surface 16. Instead of the projecting edge at one side of the tubular packing 2, punchings may be located at both sides, preferably in connection with a line of bending. The punchings enable the forming of feet when turning down material lugs which, apart from that, may have any suitable shape.

In the side walls 6 and 24, the bottom surface 16 and preferably also in a top side 34, the tubular packing 2 is formed with narrow, elongate ventilation apertures 36 which, as shown in FIG. 3, ensure good ventilation of a dough item 38 during final baking in a microwave oven. The dough item, for example a French loaf, contacts all sides which are coated with the internal susceptor coating 4. The free corner areas between the dough item 38 and the packing 2, as shown with arrows 40, are efficiently ventilated.

The ventilation openings 36 may have any shape and placing, with the placing and shape of the ventilation openings being optimized according to the actual application of the packing.

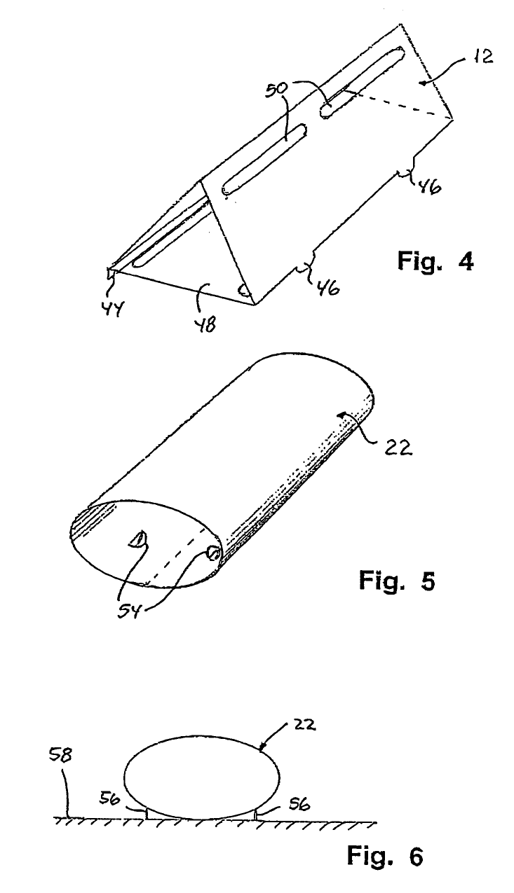

The tubular packing 12 shown in FIG. 4 has a triangular cross-section and may for example be intended for a spring roll. The packing 12 is provided with a projecting side edge 44 and with feet 46 at the opposite side of a bottom surface 48. A suitable number of ventilation openings 50 are disposed close to the angle points of the packing, right on the spot where a possible dough item is normally not in contact with the inner side of the packing, that is where optimal ventilation is ensured.

The tubular packing 22 shown in FIGS. 5 and 6 has an oval cross-section and may for example be intended for a spring roll or a corresponding fast-food product. The packing 22 is provided with a number of send-circular cut-outs 54 forming lugs of material that may be bent out and constitute support feet 56 for the packing which is thus held elevated above a support surface 58 (FIG. 6).

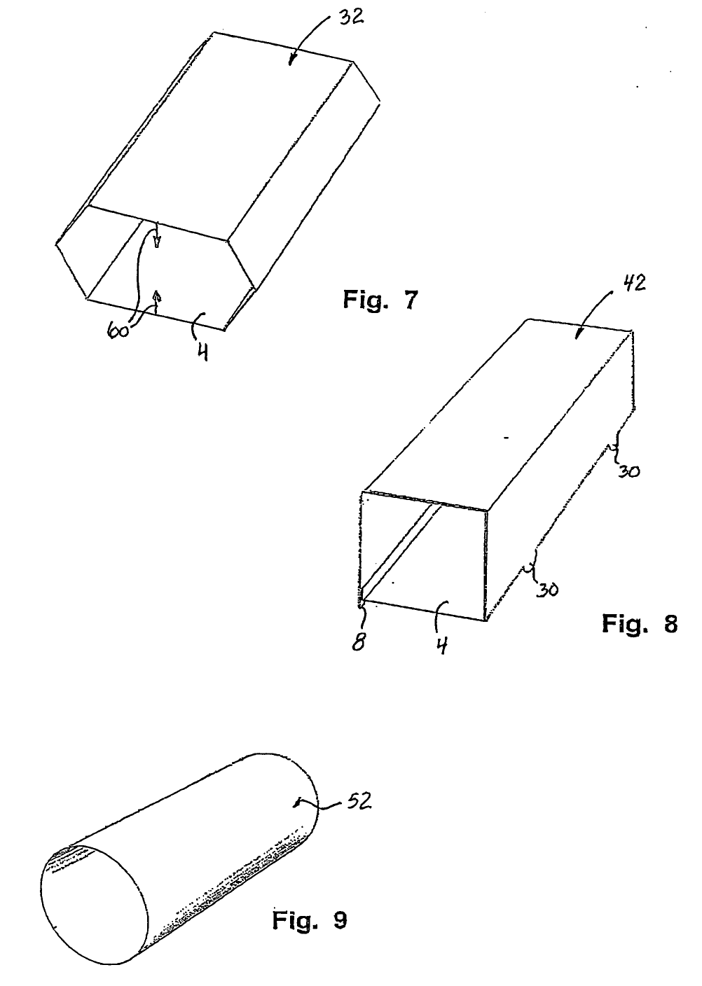

The tubular packing 32 shown in FIG. 7 has a hexagonal cross-section, and may for example be intended for a French loaf or a corresponding pre-baked dough item. The tubular packing 32 is delivered in a flat pressed condition and is only raised in connection with insertion of the dough item/French loaf, that is so that the dough item is squeezed between the bottom and top side of the packing 32, as outlined with arrows 60 and it is intended that the bottom and top sides of the packing are continuously in contact with the dough item, even if the packing may attain lesser height during final baking in a microwave oven.

FIG. 8 shows a tubular packing 42 having a square cross-section, and which for example may be intended for a French loaf; a spring roll, or a corresponding fast-food product which advantageously may be post-baked in a microwave oven. The packing 42 has, as previously described, a projecting side edge at one side, and a number of feet in the shape of bent out material lugs at the opposite side.

FIG. 9 shows a packing 52 having circular cross-section and which may be intended for a round dough item, by way of example a so-called French hot-dog. The packing 52 may also, in a way not shown, be provided with feet of the same type as those in the packing 22 (FIG. 5).

1. A packing (2,12,22,32,43,52,62,72,82,92,102) of cardboard and shaped as a tube, preferably horizontal, or a box for use in cooking dough products (38) and other fast-food products, e.g., pizza, pita bread, French loaves, hamburgers, calzones, spring rolls, or breaded products, e.g., breaded chicken or fish pieces, in a microwave oven, the packing having a susceptor coating (4) on parts of internal areas, characterised in that a lower part of the packing has such a shape or is formed with such shaped means (8,30), e.g. legs, that access for ventilation for a part of the underside of the packing is ensured, and that the packing at the said underside part and preferably in one or more side walls have ventilation openings (36), the mutual position and shape of which are adapted to the shape of the packing, of the dough product and/or of the product.

2. A packing according to claim 1 and formed as a horizontal tube with four-edges, preferably rectangular, cross-section, characterised in that the spacing means at one side of the packing are constituted by a lower, projecting edge (8) of the packing material and by feet (30) punched along a bending line at the opposite side of the packing.

3. A packing according to claim 1 and 2, characterised in that the ventilation openings are constituted by narrow, elongate openings which are formed in a bottom part of the packing along opposite sides of the bottom part and along a lower part and preferably also along an upper part of opposite side walls of the packing.

4. A packing (62) according to claim 2 and 3, characterised in having two tubular compartments and being formed with narrow elongate ventilation openings at each their side of a central partitioning wall in a bottom part as well as in an upper wall.

5. A packing (52) according to claim 1 and formed as a horizontal tube with circular cross-section and preferably open ends, characterised in that the packing at each their side of a lower central generatrix is formed with a number of e.g. semi-circular cut-outs forming lugs of material which are designed to be bent out and constitute support legs for the packing.

6. A packing (12) according to claim 1 and shaped as a horizontal tube with triangular cross-section and with preferably open ends, characterised in that the said spacing means are constituted by semi-circular cut-outs formed along bending lines at opposite, acutely angled outer edges of the packing, the cut-outs forming material lugs arranged for being bent out and constituting feet (46) for the packing, and that the ventilation openings (50) are constituted by narrow, elongate apertures formed in the side walls of the packing, preferably at both sides of the acutely angled edges of the packing.

7. A packing (22) according to claim 1 and shaped as a horizontal tube with oval cross-section and preferably open ends, characterised in that the packing at each their side of a lower central generatrix is formed with a number of e.g. semi-circular cut-outs (54) forming lugs of material which are designed to be bent out and constitute support legs for the packing.

8. A packing (32) according to claim 1 and shaped as a horizontal tube with hexagonal cross-section and preferably open ends, characterised in that the packing at each their side of a plane bottom part is formed with a number of e.g. semi-circular cut-outs forming lugs of material which are designed to be bent out and constitute support legs for the packing.

9. A packing according to claim 1, characterised in that the ventilation openings may be any desired mutual position and shape, such as oval, round, four-edged, rectangular, elongate with semi-circular ends, etc.

10. A packing according to claim 1, characterised in that the susceptor coating on an inner side of the bottom part is formed with apertures, e.g. perforations allowing the packing material to absorb fat and moisture.
